(19) United States
(12) Patent Application Publication
(10) Pub. No.: US 2011/0151168 A1
(43) Pub. Date: Jun. 23, 2011

(54) MULTI-LAYER OPTICAL ARTICLES

(76) Inventors: Scott R. Meyer, Woodbury, MN (US); Audrey A. Sherman, St. Paul, MN (US); Kevin R. Schaffer, Woodbury, MN (US)

(21) Appl. No.: 13/059,693

(22) PCT Filed: Jul. 16, 2009
(86) PCT No.: PCT/US09/50779

§ 371 Date: Feb. 18, 2011

Related U.S. Application Data
(60) Provisional application No. 61/089,976, filed on Aug. 19, 2008.

(51) Int. Cl. B32B 33/00; B32B 27/08; B32B 3/00; B29D 11/00; B29C 47/06

(52) U.S. Cl. 428/41.3; 428/516; 428/220; 264/1.7; 428/447; 428/343; 428/356; 428/355 AC; 428/355 R; 356/364

(57) ABSTRACT

Multi-layer articles are disclosed which include, a polypropylene-based film, and a layer on at least one surface of the polypropylene-based film including an ethylene-based material containing a copolymer of ethylene and at least one alpha-olefin comomoner with a density of no greater than 0.90 g/cm³ and a polydispersity index of between 1 and 4, wherein the multi-layer article is biaxially stretched. In some embodiments the multi-layer article exhibits desirable optical properties.

### FIELD OF THE DISCLOSURE

This disclosure relates to multi-layer articles, including multi-layer optical articles and uses thereof.

### BACKGROUND

A variety of articles and constructions utilize sheet materials to protect the surface of the article or construction prior to the use or application of the articles or constructions. Examples of such sheet materials include release liners and protective sheets. Release liners are typically used with articles and constructions that contain an exposed adhesive layer. The release liner is placed over the exposed adhesive layer to protect the adhesive from prematurely attaching to a substrate and to protect the adhesive from dirt, grease, etc which can interfere with the adhesive's ability to adhere to a substrate. Examples of articles and constructions that utilize release liners include virtually any article which contains an adhesive layer which may need to be protected for a period of time. Among the range of items which may contain release liners include a wide variety of tapes, labels, stickers, graphic articles and the like as well as parts, films, etc which may contain a coating of adhesive for assembly at a later time or in another location. Generally the liner is removed immediately prior to the adhesion of the article, such as peeling a label from its liner immediately before adhering it to an envelope.

Similarly, protective sheets are used to protect a wide variety of articles for storage, shipment, and the like. Protective sheets are typically used with articles that do not contain an exposed adhesive layer. Generally the protective sheet adheres to the article or construction through electrostratic forces (such as a cling film) or through the use of a coating on the protective sheet which aids in the adherence of the protective sheet to the article or construction.

### SUMMARY

Multi-layer articles are disclosed which comprise, a polypropylene-based film, and a layer on at least one surface of the polypropylene-based film comprising an ethylene-based material comprising a copolymer of ethylene and at least one alpha-olefin comomoner with a density of no greater than 0.90 g/cm³ and a polydispersity index of between 1 and 4, wherein the multi-layer article is biaxially stretched. In some embodiments the multi-layer article exhibits desirable optical properties including a luminous transmission of greater than or equal to 90%, haze of less than or equal to 4% and a retardation effect as measured by the optical angle test of less than or equal to 10°. The multi-layer articles may comprise a release liner, a protective sheet or a tape.

Also disclosed are methods of preparing multi-layer articles. In some embodiments the method comprises providing a polypropylene-based material, providing an ethylene-based material comprising a copolymer of ethylene and at least one alpha-olefin comomoner with a density of no greater than 0.90 g/cm³ and a polydispersity index of between 1 and 4, adding the polypropylene-based material to an extruder, adding the ethylene-based material to a different extruder, coextruding the polypropylene-based material and the ethylene-based material through a die to form a polypropylene-based film with a layer comprising an ethylene-based material, and simultaneously biaxially orienting the polypropylene-based film with a layer comprising an ethylene-based material to form a multi-layer article that exhibits a luminous transmission of greater than or equal to 90%, haze of less than or equal to 4% and a retardation effect as measured by the optical angle test of less than or equal to 10°.

In other embodiments, the method of preparing multi-layer articles comprises providing a polypropylene-based film, providing an ethylene-based material comprising a copolymer of ethylene and at least one alpha-olefin comomoner with a density of no greater than 0.90 g/cm³ and a polydispersity index of between 1 and 4, adding the ethylene-based material to an extruder, extruding the ethylene-based material through a die onto the polypropylene-based film to form a polypropylene-based film with a layer comprising an ethylene-based material; and simultaneously biaxially orienting the polypropylene-based film with a layer comprising ethylene-based material to form a multi-layer article that exhibits a luminous transmission of greater than or equal to 90%, haze of less than or equal to 4% and a retardation effect as measured by the optical angle test of less than or equal to 10°.

Additionally, multi-layer constructions are disclosed, these multi-layer constructions comprise an optical device, an adhesive coated on the optical device, and a liner laminated to the adhesive, wherein the liner comprises a multi-layer article comprising a polypropylene-based film, and a layer on at least one surface of the polypropylene-based film comprising an ethylene-based material comprising a copolymer of ethylene and at least one alpha-olefin comomoner with a density of no greater than 0.90 g/cm³ and a polydispersity index of between 1 and 4, wherein the multi-layer article is biaxially stretched and exhibits a luminous transmission of greater than or equal to 90%, haze of less than or equal to 4% and a retardation effect as measured by the optical angle test of less than or equal to 10°.

Also disclosed are methods of testing an optical construction, these methods comprise preparing an optical construction comprising an optical device, an adhesive coated on the optical device, and a liner laminated to the adhesive, wherein the liner comprises a multi-layer article comprising a polypropylene-based film, and a layer on at least one surface of the polypropylene-based film comprising an ethylene-based material comprising a copolymer of ethylene and at least one alpha-olefin comomoner with a density of no greater than 0.90 g/cm³ and a polydispersity index of between 1 and 4, wherein the multi-layer article is biaxially stretched and exhibits a luminous transmission of greater than or equal to 90%, haze of less than or equal to 4% and a retardation effect as measured by the optical angle test of less than or equal to 10°, placing the optical construction between 2 linear polarizers set perpendicular to each other; and rotating the optical construction to determine the optical angle.

### DETAILED DESCRIPTION

The development of adhesives, especially pressure sensitive adhesives, for areas such as the medical, electronic and optical industries is increasing. The requirements of these industries place additional demands upon the pressure sensitive adhesive which in turn places greater demands upon the release liners used to deliver the adhesives.

New liners are desirable which have the features of being able to provide the desired release performance, are essentially free of low molecular weight compounds, especially compounds such as silicones or fluorochemicals, are relatively inexpensive to produce and also in some instances have desirable optical properties.

An example of such an application is the area of hard disk drives. In the assembly of hard disk drives, adhesive sheets are used for various purposes such as temporarily fixing parts in place, holding labels in place, sealing of holes, etc. Typically these adhesive sheets are adhered to a release liner until they are used. Many of the common release liners contain a silicone coating. Unfortunately, many of silicone coatings contain low molecular weight silicone molecules such as silicone oils, silicone resins, etc which can transfer to the adhesive layer. When the adhesive layer is used in the hard disk drive device these low molecular weight molecules can become volatilized and deposit onto components of the hard disk drive and form an undesirable silicone layer upon the components.

Similarly, protective sheets are desirable which have the desired adhesion to certain substrates, are essentially free of low molecular weight compounds, especially compounds such as silicones or fluorochemicals, are relatively inexpensive to produce and also in some instances have desirable optical properties.

Multi-layer articles are disclosed that may be release liners and/or protective sheets. These multi-layer articles comprise a polypropylene-based film, and a layer on at least one surface of the polypropylene-based film of an ethylene-based material. The multi-layer articles are biaxially stretched. The articles may have desirable optical properties. In some embodiments the multi-layer articles exhibit a luminous transmission of greater than or equal to 90%, haze of less than or equal to 4% and a retardation effect as measured by the optical angle test of less than or equal to 10°.

Multi-layer articles which can function as release liners and protective sheets and also provide desirable optical features are desirable as more and more demanding uses are found for constructions which contain such articles. For example, in optical articles it may be desirable to observe the adhesive surface of the optical article prior to removal of the liner to observe if any coating defects are present. Similarly, it may be desirable to inspect articles and constructions protected with protective sheets without having to remove the protective sheet. For example, an automobile shipper may insist upon a visual inspection of a sheet protected automobile prior to shipment to insure no defects are present in the painted or other protected surfaces.

As used herein the term “multi-layer article” refers to an article which contains more than one layer. The layers generally comprise different materials. “Multi-layer optical articles” are those multi-layer articles which are optically clear or optically transmissive.

Unless otherwise indicated, “optically clear” refers to an adhesive or article that has a high light transmittance over at least a portion of the visible light spectrum (about 400 to about 700 nm), and that exhibits low haze.

Unless otherwise indicated, “optically transmissive” refers to an adhesive or article that has a high light transmittance over at least a portion of the visible light spectrum (about 400 to about 700 nm).

As used herein, the term “polypropylene-based material” refers to a polymeric material that contains at least polypropylene, and may contain other polymers or additives. Typically polypropylene-based materials comprise at least 50% by weight polypropylene.

As used herein, the term “polypropylene-based film” refers to a film that is prepared from a polypropylene-based material.

As used herein, the term “ethylene-based material” refers to a polymeric material prepared from at least ethylene monomers. Generally the ethylene-based material is a copolymer containing at least one other olefinic monomer in addition to ethylene.

As used herein, the term “retardation effect” refers to an optical effect characteristic of birefringent materials. When light enters a birefringent material, the process may be described as the light being broken up into the fast (called the ordinary ray) and slow (called the extraordinary ray) components. Because the two components travel at different velocities, the waves get out of phase. When the rays are recombined as they exit the birefringent material, the polarization state has changed because of this phase difference.

As used herein, the term “birefrigent material” refers to a material which exhibits birefringence. Birefringence is the phenomenon of double refraction of light wavefronts in a transparent, molecularly ordered material produced by the existence or orientation-dependent differences in refractive index. The term birefringence also commonly refers to the refractive index difference experienced by a transmitted wave through such a material. Wavefronts of light incident on a birefringent specimen are split into ordinary and extraordinary components that can recombine after emergence from the specimen to produce linearly, elliptically, or circularly polarized light.

The term “adhesive” as used herein refers to polymeric compositions useful to adhere together two adherends. Examples of adhesives are non-tacky adhesives (i.e., cold-seal adhesives), and pressure sensitive adhesives.

Non-tacky adhesives have limited or low tack to most substrates but can have acceptable adhesive strength when paired with specific target substrates or when two layers of the non-tacky adhesives are contacted. The non-tacky adhesive adheres by affinity.

Pressure sensitive adhesive (PSA) compositions are well known to those of ordinary skill in the art to possess properties including the following: (1) aggressive and permanent tack, (2) adherence with no more than finger pressure, (3) sufficient ability to hold onto an adherend, and (4) sufficient cohesive strength to be cleanly removable from the adherend. Materials that have been found to function well as PSAs are polymers designed and formulated to exhibit the requisite viscoelastic properties resulting in a desired balance of tack, peel adhesion, and shear holding power. Obtaining the proper balance of properties is not a simple process.

As used herein, the term “silicone polyoxamide polymer” refers to a copolymer containing silicone groups and at least one oxamide group. The terms “silicone” and “siloxane” are used interchangeably and refer to units with dialkyl or diaryl siloxane (—SiR₂O—) repeating units. An “oxamide group” is one with the general structure —NR—C(O)—C(O)—NR—, where C(O) represents a carbonyl group and R is a hydrogen atom, alkyl group or aryl group.

As used herein, the term “biaxially stretched,” when used to describe a film, means the film has been stretched in two different directions, a first direction and a second direction, in the plane of the film. Typically, but not always, the two directions are substantially perpendicular and are in the longitudinal or machine direction (“MD”) of the film (the direction in which the film is produced on a film-making machine) and the transverse direction (“TD”) of the film (the direction perpendicular to the MD of the film). The MD is sometimes referred to as the Longitudinal Direction (“LD”). Biaxially stretched films may be sequentially stretched, simultaneously stretched, or stretched by some combination of simultaneous and sequential stretching. Further, such stretching can result in films that are balanced or unbalanced. Films having an anisotropic molecular orientation may exhibit anisotropy aligned parallel to any major film axis, so long as the desirable property attributes described herein are met.

As used herein, the term “simultaneously biaxially stretched,” when used to describe a film, means that significant portions of the stretching in each of the two directions are performed simultaneously.

As used herein, the term “stretch ratio,” as used to describe a method of stretching or a stretched film, means the ratio of a linear dimension of a given portion of a stretched film to the linear dimension of the same portion prior to stretching. For example, in a stretched film having an MD stretch ratio (“MDR”) of 5:1, a given portion of unstretched film having a 1 cm linear measurement in the machine direction would have 5 cm measurement in the machine direction after stretch. In a stretched film having a TD stretch ratio (“TDR”) of 9:1, a given portion of unstretched film having a 1 cm linear measurement in the transverse direction would have 9 cm measurement in the transverse direction after stretch.

Unless context requires otherwise, the terms “orient,” “draw,” and “stretch” are used interchangeably throughout, as are the terms “oriented,” “drawn,” and “stretched,” and the terms “orienting,” “drawing,” and “stretching.”

Multi-layer articles which can function as release liners and protective sheets and also provide desirable optical features are disclosed. The multi-layer articles comprise a polypropylene-based film, and a layer on at least one surface of the polypropylene-based film comprising an ethylene-based material. The multi-layer articles are biaxially stretched.

The polypropylene-based film is prepared from a polypropylene-based material. Typically the polypropylene-based material is polypropylene, although other polymeric materials or other additives may be present. One particular polypropylene homopolymer which is useful in the preparation of the multi-layer articles is PP 3376 commercially available from ATOFINA CHEMICALS.

Typically the polypropylene-based film is prepared using solventless processes, although the film could be prepared using solvent coating techniques if desired. Generally, melt extrusion techniques are used to prepare the polypropylene-based film. In such techniques the polypropylene and any desired additional materials are added to an extruder, and the polypropylene-based material is extruded into a film. Examples of useful extruders include single screw extruders, twin screw extruders, disk extruders, reciprocating single screw extruders, pin barrel single screw extruders and the like.

In addition to polypropylene, the polypropylene-based material may contain other optional materials. Some of these materials may be polymeric, such as, for example, copolymers of polypropylene. In addition, other property modifiers, such as antistatic agents, fillers, flame retardants, stabilizers, antioxidants, compatibilizers and the like can be added to the polypropylene-based material provided they do not interfere with the desired properties of the polypropylene-based material. Typically, for simplicity, the polypropylene is used alone without additional additives.

The polypropylene-based film may optionally have coatings on the side opposite to the side of the ethylene-based material. Examples of such coatings include, for example, hard coats, tinted coatings, antistatic coats, and the like. Such coatings may be applied for a variety of uses. One example is to indicate that the multi-layer articles is present in an construction. Because of the desirable optical properties that the multi-layer article may have, it may be difficult for a user to determine if the multi-layer article is present in a construction. Therefore, in some embodiments, it may be useful for the multi-layer article to be tinted to make it clear to the user that the multi-layer article is present. The polypropylene-based film may also be printed upon in discrete sections for the same purpose. Printing may be carried out in a variety of ways, including screen printing, gravure printing or ink jet printing and may take the form of a variety of indicia.

The multi-layer articles contain a layer on at least one surface of the polypropylene-based film which comprises an ethylene-based material. The ethylene-based materials are copolymers of ethylene and alpha-olefins having from 3 to about 10 carbon atoms. Copolymers of ethylene and 1-butene, 1-hexene, 1-octene, and combinations thereof are particularly useful.

The copolymers are generically described as very low density polyethylene (VLDPE) and have been described as “plastomers”, a polymer having thermoplastic and elastomeric characteristics. Useful copolymers generally have a density no greater than 0.90 grams per cubic centimeter (g/cm³). Some copolymers have a density of no greater than 0.89 g/cm³ or a density no greater than 0.88 g/cm³. Lower density copolymers may provide a lower release value, and values can be tailored to suit the desired release performance by blending copolymers of varying types.

The useful copolymers generally have a narrow molecular weight distribution as defined by having a polydispersity of between about 1 and 4, and or even between about 1.5 and 3.5. Polydispersity is defined as the ratio of the weight average molecular weight to the number average molecular weight.

Typically such polymers are prepared using transition metal catalysts such as Ziegler-Natta catalysts or metallocene catalysts. Some examples of such materials include the Ziegler-Natta catalyst produced J-REX materials from Japan Polyolefins and the EXCELLEN materials from Sumitomo Chemical Co. Some examples of metallocene catalyst produced materials include KERNEL materials from Japan Polychem Corp., SUMIKASEN E, EXCELLEN E, and EXCELLEN EX materials from Sumitomo Chemical Co. Other examples include the EXACT copolymers from Exxon and ENGAGE and INFUSE Olefin Block Copolymers from Dow Chemical. Polymers prepared by metallocene catalysts are especially useful.

The EXACT copolymers are particularly suitable for the preparation of the multi-layer articles of this disclosure. These copolymers form films that are not fusible at ambient temperature, and will not block, i.e., stick to underlying layers, when the film is wound into a roll.

In some embodiments, the ethylene-based material consists essentially of an ethylene copolymer having a density of no greater than 0.90 g/cm³, and is substantially free of any polyethylene having a density of 0.91 g/cm³ or greater.

One advantage of coatings of the ethylene-based materials is that they act as release materials (i.e. have low adhesion) when adhered to adhesives such as pressure sensitive adhesives but can also function as non-tacky adhesives for certain substrates. This permits multi-layer articles containing layers of the ethylene-based materials described above to be used as both release liners and protective sheets.

While not wishing to be bound by theory, it is believed that the ethylene-based materials of this disclosure are able to function as release materials for release liners due to their low surface energy properties. Further, it is believed that because these materials are soft and conformable, they are also able to function as non-tacky adhesives for protective sheets due to their ability to spontaneously wet certain surfaces.

The ethylene-based material may be blended with other components to modify the properties of the ethylene-based material. Among the useful components that may be blended with the ethylene-based material are silicone polymers such as silicone elastomeric and thermoplastic polymers. Such polymers should not be low molecular weight species to avoid transfer of the silicone species from the ethylene-based material layer.

One useful class of silicone polymers which may be used as additives for the ethylene-based material are silicone polyoxamide polymers. Examples of suitable silicone polyoxamide polymers are described, for example in US Patent Publication 20070148474. Silicone polyoxamide polymers are copolymers comprising at least two repeat units of Formula I:

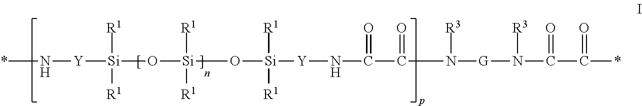

In this formula, each R¹ is independently an alkyl, haloalkyl, aralkyl, alkenyl, aryl, or aryl substituted with an alkyl, alkoxy, or halo. Each Y is independently an alkylene, aralkylene, or a combination thereof. Subscript n is independently an integer of 0 to 1500 and subscript p is an integer of 1 to 10. Group G is a divalent group that is the residue unit that is equal to a diamine of formula R³HN-G-NHR³ minus the two —NHR³ groups (i.e., amino groups). Group R³ is hydrogen or alkyl or R³ taken together with G and with the nitrogen to which they are both attached forms a heterocyclic group. Each asterisk indicates the position of attachment of the repeating unit to another group such as another repeat unit.

The amount of silicone polyoxamide polymer blended with the ethylene-based material depends upon the desired properties for the layer formed by the ethylene-based material. For example, if the multi-layer article is a protective sheet, it may be desirable to add no silicone polyoxamide polymer. If, however, the multi-layer article is a release liner, it may be desirable to blend the ethylene-based material with 0.1-10 weight %, 0.1-5 weight % or even 0.5-5 weight % of a silicone polyoxamide polymer. In some embodiments 2 weight % silicone polyoxamide polymer is blended with the ethylene-based material.

Besides the silicone polyoxamide polymers described above, other additives may optionally be blended with the polyethylene-based material to give the desired properties. For example, antistatic agents may be added to help dissipate static charge when the liner or protective sheet is removed.

Additionally, it may in some instances be desirable to blend colorants to tint the ethylene-based material layer. Because of the desirable optical properties that the multi-layer article may have, it may be useful for the multi-layer article to be tinted to make it clear to the user that the multi-layer article is present. The polyethylene-based layer may also be printed upon in discrete sections for the same purpose. Printing may be carried out in a variety of ways, including screen printing, gravure printing or ink jet printing.

In some embodiments, especially where the multi-layer article is to be used as a protective sheet, it may be desirable to add materials to the polyethylene-based material to make it tackier or even to add a very thin coating of adhesive material on top of the polyethylene-based layer. The adhesive material is generally a pressure sensitive adhesive and may be coated onto the polyethylene-based layer as a continuous or discontinuous layer with a thickness much less than the thickness of the polyethylene-based layer.

A variety of multi-layer articles are disclosed, including release liners and protective sheets. Release liners are articles containing at least one release surface. A release surface is defined as one that has a lack of adhesion, which provides an easy release from substrates, in particular adhesive coated substrates. When applied to an adhesive coated surface, release liners adhere only lightly and are easily removed. A wide range of release liners are known, many of which are multi-layer articles with a carrier layer (which may be, for example, paper, polymeric film, etc) and a release coating on the carrier layer. Typically the release coatings are low surface energy materials such as silicones, fluorochemicals or olefinic materials. Generally release liners are used in constructions to provide temporary protection of an adhesive coated surface to prevent premature adhesion and/or contamination of the adhesive surface.

In some embodiments, the release liner may optionally be structured, and the structure on the release liner can be used to create an inverse of the structure on an adhesive, resulting in a structured adhesive. For example, for every groove in the adhesive, the release liner has a corresponding ridge. The ridges would protrude from a liner reference plane, which is defined by the liner surface at the base of each ridge. The dimensions of each ridge correspond to the desired dimensions of each groove in the adhesive. For example, the groove width at the reference plane corresponds to the ridge width at the liner reference plane. In embodiments comprising a protrusion from the reference plane or from the real walls on the adhesive structured surface, the release liner will comprise a corresponding depression. The structure on the release liner can be created in a number of known ways, including embossing the liner to form a structured surface or printing a structure on the surface.

Besides use as release liners, the multi-layer articles of this disclosure can also be used to prepare adhesive-coated articles such as tapes. Tapes typically contain a backing with an adhesive coated on one side and a release coating on the opposite side. Thus when the tape is rolled up the adhesive contacts the release coating permitting the tape to be unrolled again when used. The release coatings on tapes are sometimes called “low adhesion backsizes” or “LABs”. The polyethylene-based materials may function as LABs.

To prepare a tape, a multi-layer release liner article may be prepared and then coated on the side opposite to the release coating with an adhesive coating. This coating may be applied with solvent-borne (either in solvent or water) or solventless (such as, for example, hot melt coating. Such techniques are commonly used in the preparation of tapes.

The adhesive may be any suitable adhesive, but typically will be a pressure sensitive adhesive. Examples of suitable pressure sensitive adhesives include, for example: acrylate- and methacrylate-based pressure sensitive adhesives; natural rubber-based pressure sensitive adhesives; synthetic rubber-based pressure sensitive adhesives; olefin-based pressure sensitive adhesives; block copolymer-based pressure sensitive adhesives such as styrene-isoprene block copolymers for example; vinyl ether-based pressure sensitive adhesives; polyurethane- or polyurea-based pressure sensitive adhesives and silicone based pressure sensitive adhesives. Mixtures of these pressure sensitive adhesives may also be used in some embodiments. Generally the adhesive is chosen based upon the desired use of the tape, as well as other factors such as cost, ease of handling and release performance of the adhesive with the release coating.

Protective sheets are a class of articles which are used to temporary cover and protect a variety of surfaces. The surfaces may be films, articles, substrates, or parts of larger constructions. Typically the protective sheet lightly adheres to the surface to be protected. The light adhesion of the protective sheet for the surface to be protected permits the protective sheet to adhere to the surface and remain adhered through handling, shipment, process steps, etc, but the protective sheet can be easy removed when desired. In some instances this light adhesion is achieved through electrostatic forces such as in the case of a cling films used as protective sheets. In other instances a coating is placed on the protective sheet which may function as a non-tacky adhesive. Non-tacky adhesives have little or no tack and adhere through affinity. The ethylene-based materials of the present disclosure have been found to function as non-tacky adhesives for a variety of different surfaces, including metal surfaces and film surfaces.

Some multi-layer articles of the present disclosure have desirable optical properties. Generally the multi-layer articles are at least optically transmissive. In some embodiments that multi-layer articles are optically clear. The optically clear multi-layer articles may have a luminous transmission of at least 90% and a haze of less than 5%. In some embodiments the optically clear multi-layer articles have a luminous transmission of at least 92% and a haze of less than 4%. Additionally, some of the multi-layer articles may be characterized by their clarity. Some embodiments have a clarity of 90% or greater or even 92% or greater.

Another desirable optical property that the multi-layer articles may possess is a retardation effect of linearly polarized light of less than or equal to 10° when measured by the optical angle test described herein.

The retardation effect is a commonly observed phenomenon for birefringent materials. When light enters a birefringent material, the process may be described as the light being broken up into the fast (called the ordinary ray) and slow (called the extraordinary ray) components. Because the two components travel at different velocities, the waves get out of phase. When the rays are recombined as they exit the birefringent material, the polarization state has changed because of this phase difference.

One method for determining the retardation effect of a birefringent material, such as the multi-layer articles of this disclosure, is to determine the optical angle. An example of an optical angle test that is particularly useful, is one that uses an apparatus with 2 linear polarizers set perpendicular to each other (i.e. cross polarizers) and a light source. When light produced by the light source passes through the cross polarizers, no light is observed passing through the second polarizer. However, when a article such as a multi-layer article of this disclosure is placed between the polarizers, some light may be observed to pass through the second polarizer due to the retardation effect. When this occurs, rotation of the article may be effected until no light or essentially no light is observed passing through the second polarizer. The angle that the article was rotated to achieve this effect is defined as the optical angle.

The multi-layer articles of this disclosure generally have a retardation effect on at least a portion of the article, as measured by the optical angle test, of less than 10°. In some embodiments the optical angle is less than 10° across the width of the article. It is difficult to achieve such optical angle values across the width of the article because the article is stretched. Stretching of articles often tends to increase the birefringence. The articles may be any desirable width, even relatively wide widths such as at least 152 centimeters (60 inches), 305 centimeters (120 inches) or even 610 centimeters (240 inches) or greater.

This same optical angle test method can be used with a variety of optical articles, including for example optical films coated with an optically clear adhesive. One advantageous use of, for example, multi-layer release liners of this disclosure includes the attachment of the multi-layer release liner to the optical film coated with adhesive to form an optical construction. This construction may then be tested using the optical angle test to determine the optical angle of the optical film/adhesive combination without having to remove the release liner prior to testing. Such testing is possible because the multi-layer release liner contributes relatively little to the retardation effect. Similarly, the same type of optical angle testing could be carried out with constructions containing multi-layer protective sheets of this disclosure.

This disclosure includes a method of testing an optical construction comprising: preparing an optical construction comprising an optical film; an adhesive coated on the optical film; and a liner laminated to the adhesive, wherein the liner comprises a multi-layer article comprising a polypropylene-based film, and a layer on at least one surface of the polypropylene-based film comprising a copolymer of ethylene and at least one alpha-olefin comomoner with a density of no greater than 0.90 g/cm³ and a polydispersity index of between 1 and 4, wherein the multi-layer article is biaxially stretched and exhibits a transmission of greater than or equal to 90%, haze of less than or equal to 4% and a retardation effect as measured by the optical angle test of less than or equal to 10°; placing the optical construction between 2 linear polarizers set perpendicular to each other; and rotating the optical construction to determine the optical angle.

The multi-layer articles of this disclosure may be prepared in a variety of ways, for example, by coextrusion or by coating techniques. In some embodiments coextrusion is desirable, especially when the coextrusion equipment is located adjacent to stretching equipment. In this way the multi-layer articles can be formed and stretched in a continuous operation.

Coextrusion is a useful technique to form multi-layer articles containing polymeric webs. Coextrusion of polymeric webs can occur by passing different melt streams from different extruders into a multiple layer feed block and a film die, or into a multiple manifold die. The feedblock technique merges at least two different materials in a feedblock and then feeds them to a die as a layered stack, which becomes a layered sheet as it leaves the die. A multiple manifold die, on the other hand, combines different molten streams from different extruders at a die lip. The layers are formed and brought together in the melt state, thereby allowing for improved adhesion to one another.

When materials that are coextruded have low compatability with each other, like polyethylene and polypropylene, typically a tie layer is coextruded between the 2 layers to improve their adhesion to each other. Such tie layers are polymeric species which have good compatability with both of the coextruded materials. Embodiments of the present disclosure, typically do not require tie layers.

In some embodiments of this disclosure, a polypropylene-based material is placed in one extruder and a polyethylene-based material is placed in another extruder. Optional additives as discussed above may be added to one or both of the materials if desired. Also, if additional layers are desired, additional materials may be placed in additional extruders. Typically, the different melt streams from the different extruders are directed into a multiple layer feed block and a film die.

The multi-layer articles of this disclosure may also be prepared using coating techniques. In these coating techniques, a pre-made polypropylene based film is coated with the polyethylene-based material. The pre-made polypropylene-based film may be prepared by conventional extrusion or casting techniques and may contain optional additives as described above. The polyethylene-based material may be solvent borne, water borne or solventless, it may be at room temperature or elevated temperature (i.e. hot melt coating) and may contain optional additives as described above. The polyethylene-based material may be coated using typical coating techniques such as, for example, die coating, knife coating, roll coating, gravure coating, rod coating, curtain coating, air knife coating and printing techniques such as screen printing or inkjet printing. If additional layers are desired, such layers may be prepared through the use of additional coating steps.

Generally, after preparing a multi-layer article comprising a polypropylene-based film and a polyethylene-based layer, the article is stretched. New techniques for manufacturing polymeric films have been developed. These techniques include stretching a polymer film in a first direction and stretching the polymer film in a second direction different than the first direction forming a biaxially stretched polymeric film. At least a portion of the stretching in the second direction occurs simultaneously with the stretching in the first direction.

Generally, for stretched films with optical properties, the films are simultaneously biaxially stretched. This is because attempts to biaxially stretch polymeric films in a sequential manner may often produce polymeric optical films with “patchy” optical properties and attributes. It has been observed that the final stretch direction imparts a greater influence on the optical properties and attributes of the biaxially stretched polymeric optical film.

Simultaneous biaxial stretching may be carried out with a tenter apparatus such as is described in U.S. Pat. No. 5,051,225. The multi-layer construction which is fed into the tenter apparatus may be produced by coextrusion as described above and fed into the tenter in an in line process. Alternatively, the multi-layer construction may be prepared in one location, rolled up, and shipped to the tenter location and fed into the tenter. Typically the multi-layer construction is heated as it is stretched.

The amount of stretching in the MD may be different than the amount of stretching in the TD. The amount of stretching in the MD may be up to 10% or 25% or 50% greater than the amount of stretching in the TD. The amount of stretching in the TD may be up to 10% or 25% or 50% greater than the amount of stretching in the MD. Surprisingly, this “unbalanced” stretching helps to provide the film with substantially uniform in-plane retardance.

Upon exiting the tenter, the multi-layer construction may be subjected to post-treatment. This post-treatment may include maintaining the construction at a desired temperature with no significant stretching. This treatment can be referred to as heat set or anneal, and may be performed to improve the properties of the final film, such as dimensional stability. Post-treatment may also involve cooling. Cooling may begin before or after the onset of stretching. Cooling may be provided by forced air convection, for example.

The stretched multi-layer constructions may have a range of widths, even relatively wide widths such as at least 152 centimeters (60 inches), 305 centimeters (120 inches) or even 610 centimeters (240 inches) or greater.

The multi-layer articles of this disclosure can be used to prepare multi-layer constructions. These constructions may have desirable optical properties. For example, the multi-layer article may be a release liner and can be laminated to a variety of adhesive coated materials to form a multi-layer construction. In some embodiments the adhesive coated material is an optical device. Optical devices include for example, adhesive-coated optical films as well as other adhesive-coated optical devices. Suitable optical films include films that generate an optical effect such as transmission, reflection, etc. Examples of optical films include visible mirror films, color mirror films, solar reflective films, diffusive films, infrared reflective films, ultraviolet reflective films, reflective polarizer films such as brightness enhancement films or dual brightness enhancement films, absorptive polarizer films, optically clear films, tinted films, and antireflective films. Other optical devices with an adhesive coating include, for example, graphic articles and information display devices. Examples of information display devices include devices with a wide range of display area configurations including liquid crystal displays, plasma displays, front and rear projection displays, cathode ray tubes and signage. Such display area configurations can be employed in a variety of portable and non-portable information display devices including personal digital assistants, cell phones, touch-sensitive screens, wrist watches, car navigation systems, global positioning systems, depth finders, calculators, electronic books, CD or DVD players, projection television screens, computer monitors, notebook computer displays, instrument gauges, instrument panel covers, signage such as graphic displays (including indoor and outdoor graphics, bumper stickers, etc) reflective sheeting and the like.

Some embodiments of the multi-layer release liners of this disclosure are particularly suited for use with optical devices because their desirable optical properties can permit inspection and/or testing of the optical device to be carried out without removal of the release liner. It may be desirable, for example to visually inspect an optical device which is coated with an adhesive prior to removal of the release liner and attachment to a substrate to check for coating defects, contamination of the adhesive, etc. Additionally, in some embodiments the optical angle test described above can be carried out without removal of the release liner.

In other multi-layer constructions the multi-layer article is a protective sheet. The protective sheet can be attached to wide variety of surfaces. For example, the protective sheet may be attached to a film, a substrate, or a device. Examples of films include, for example, optical films, decorative films, graphic films, retroreflective sheeting and the like. Examples of substrates include, for example, metal sheets, windows, wooden surfaces, polymeric substrates such as, for example, polyethylene terephthalate (PET), polymethylmethacrylate (PMMA) and polycarbonate (PC) which may be relatively soft and easy to scratch, and the like. Examples of devices include information display devices such as devices with a wide range of display area configurations including liquid crystal displays, plasma displays, front and rear projection displays, cathode ray tubes and signage. Such display devices may use protective sheets during assembly, storage or shipping. It may be desirable to visually inspect the device for defects, damage, dirt, etc without removing the protective sheet.

### EXAMPLES

These examples are merely for illustrative purposes only and are not meant to be limiting on the scope of the appended claims. All parts, percentages, ratios, etc. in the examples and the rest of the specification are by weight, unless noted otherwise. Solvents and other reagents used were obtained from Sigma-Aldrich Chemical Company; Milwaukee, Wis. unless otherwise noted.

### Table of Abbreviations

| Abbreviation or | |
|---|---|
| Trade | |
| Designation | Description |
| 14K PDMS | A polydimethylsiloxane diamine with an average molecular weight of |
| diamine | about 14,000 g/mole that was prepared as described in U.S. Pat. |
| | No. 5,214,119. |
| THF | Tetrahydrofuran |
| PET | polyethylene terephthalate |
| DEO | Diethyl oxylate |
| PSA-1 | Adhesive tape having an adhesive layer of 25 micrometer (1 mil) |
| | thickness with a composition of 93 wt % iso-octyl acrylate and 7 wt % |
| | acrylamide on a PET backing of 51 micrometer (2 mils) thickness with |
| | a silicone-coated paper liner. |
| PSA-2 | Adhesive transfer tape having an adhesive layer of 51 micrometer (2 |
| | mils) thickness with a composition of 90 wt % iso-octyl acrylate and |
| | 10 wt % acrylic acid between 2 liners, a fluorochemical liner (liner |
| | 5932 available from 3M Company, St. Paul, MN) and a polyolefin |
| | liner. |
| PP | Polypropylene, PP 3376 commercially available from AUTOFINA |
| | CHEMICALS, Axis, AL. |
| Polymeric | Silicone polyoxamide prepared as described in Preparative Examples 1 |
| Additive-1 | and 2 below. |
| PE | Polyethylene-based copolymer commercially available from Exxon as |
| | “EXACT 5181”. |

### Test Methods

### Release Test

Samples were prepared for release testing by attaching 3-layer laminates of backing/adhesive/liner to a 17.8 centimeter by 33 centimeter steel panel using double-coated adhesive tape (commercially available from 3M Company under the trade designation “410B”) via the non-release side of the liner using a 2.3 kg rubber roller. The backing/adhesive was then peeled from the liner at 180° at a rate of 2.3 meters/minute (90 inches/minute). All tests were done in a facility at constant temperature (20° C.) and constant humidity (50% RH). In the case of shocky peel, the minimum, maximum and average peel values are all reported to indicate the level of shockiness and a description of the peel was also included. To determine the readhesion value, the peeled adhesive strip was applied to the surface of a clean stainless steel plate by means of a 2 kg rubber roller. The readhesion value was a measure of the force required to pull the tape from the glass surface at an angle of 180° at a rate of 2.3 meters/minute (90 inches/minute). The peel tester used for all examples was an IMass slip/peel tester (Model 3M90, commercially available from Instrumentors Inc., Strongville, Ohio). Measurements were obtained in grams/inch and converted to Newtons per decimeter.

### Peel Force Testing

This peel adhesion test is similar to the test method described in ASTM D 3330-90, substituting using either a stainless steel sheet or a polyethylene terephthalate (PET) sheet as the substrate. Protective sheet samples were cut into 2.54 centimeter by 15 centimeter strips. Each strip was then adhered to a 10 centimeter by 20 centimeter clean substrate. The substrate was either stainless steel or PET, and the strip was adhered with the PE side down using a 2-kilogram roller passed twice over the strip. The bonded assembly dwelled as specified and was tested for 180° peel adhesion using an IMASS slip/peel tester (Model 3M90, commercially available from Instrumentors Inc., Strongsville, Ohio) at a rate of 2.3 meters/minute (90 inches/minute) over a five second data collection time. Measurements were obtained in grams/inch and converted to Newtons per decimeter.

### Optical Angle Test

The optical angle was measured with an apparatus with 2 linear polarizers set perpendicular to each other (i.e. cross polarizers) and a light source. When light produced by the light source passed through the cross polarizers, no light was observed passing through the second polarizer. However, when the multi-layer article to be tested was placed between the polarizers, some light was observed to pass through the second polarizer due to the retardation effect. The article was rotated until no light or essentially no light was observed passing through the second polarizer. The angle that the article was rotated to achieve this effect was recorded as the optical angle.

### Luminous Transmission and Haze Test

The luminous transmittance and haze of all samples were measured according to American Society for Testing and Measurement (ASTM) Test Method D 1003-95 5 (“Standard Test for Haze and Luminous Transmittance of Transparent Plastic”) using a TCS Plus Spectrophotometer from BYK-Gardner Inc.; Silver Springs, Md.

### Clarity Test

Optical clarity was determined using a transmission accessory mounted on a spectrophotometer (commercially available from BYK Gardner, Columbia, Md. under the trade designation Gardner BYK Color TCS Plus).

### Preparative Example 1

A sample of 14K PDMS diamine (830.00 grams) was placed in a 2-liter, 3-neck resin flask equipped with a mechanical stirrer, heating mantle, nitrogen inlet tube (with stopcock), and an outlet tube. The flask was purged with nitrogen for 15 minutes and then, with vigorous stirring, DEO (33.56 grams) was added dropwise. This reaction mixture was stirred for approximately one hour at room temperature and then for 75 minutes at 80° C. The reaction flask was fitted with a distillation adaptor and receiver. The reaction mixture was heated under vacuum (133 Pascals, 1 Torr) for 2 hours at 120° C. and then 30 minutes at 130° C., until no further distillate was able to be collected. The reaction mixture was cooled to room temperature to provide the compound of Formula I product. Gas chromatographic analysis of the clear, mobile liquid showed that no detectable level of diethyl oxalate remained. The ester equivalent weight was determined using ¹H NMR (equivalent weight equal to 7,916 grams/equivalent) and by titration (equivalent weight equal to 8,272 grams/equivalent).

### Preparative Example 2

Into a 20° C. 10-gallon (37.85-Liter) stainless steel reaction vessel, 18,158.4 grams of 14K ethyl oxalylamidopropyl terminated polydimethyl siloxane (titrated MW=14,890, which was prepared in a fashion similar to the description in the Preparative Example 1, with the volumes adjusted accordingly) was placed. The vessel was subjected to agitation (75 revolutions per minute (rpm)), and purged with nitrogen flow and vacuum for 15 minutes. The kettle was then heated to 80° C. over the course of 25 minutes. Ethylene diamine (73.29 grams, GFS Chemicals) was vacuum charged into the kettle, followed by 73.29 grams of toluene (also vacuum charged). The kettle was then pressurized to 1 psig (6894 Pa) and heated to a temperature of 120° C. After 30 minutes, the kettle was heated to 150° C. Once a temperature of 150° C. was reached, the kettle was vented over the course of 5 minutes. The kettle was subjected to vacuum (approximately 65 mm Hg, 8665 Pa) for 40 minutes to remove the ethanol and toluene. The kettle was then pressured to 2 psig (13789 Pa) and the viscous molten polymer was then drained into TEFLON coated trays and allowed to cool. The cooled silicone polyoxamide product, polydiorganosiloxane polyoxamide block copolymer, was then ground into fine pellets.

### Example A

This example illustrates a method for making simultaneously biaxially oriented coextruded PP/PE films.

PP and PE were placed in single screw extruders and coextruded to generate a 2 layer polymer melt that was extruded through a slot die and cast onto a water-cooled steel casting wheel rotating at about 11.0 meters per minute. The casting wheel was maintained at a temperature of about 35° C. using internal water circulation and by immersing the casting wheel in a water bath.

The cast sheet was passed through a bank of IR heaters set to about 310° C. to preheat the cast film prior to simultaneous stretching in the tenter oven. The cast and preheated film was immediately simultaneously stretched in longitudinal (MD) and transverse (TD) directions to produce biaxially oriented film. Final area stretch ratio of about 47:1 was used. The MD and TD ratios were kept approximately constant at about 5.4 times for the MDR and about 8.7 times for the TDR, so that the film was stretched either about the same in each of the MD and TD, or preferably, more in the MD than in the TD.

The tenter oven temperature set points used in the preheat zones was 156° C., in the stretching zones was 157° C., and in the annealing zones was 153° C. The film was about 50 micrometers thick and the slit widths were about 162 centimeters.

### Example B

This example illustrates a method for making simultaneously biaxially oriented coextruded PP/PE+Polymeric Additive-1 films.

PP and PE/Polymeric Additive-1 were placed in single screw extruders and coextruded to generate a 2 layer polymer melt that was extruded through a slot die and cast onto a water-cooled steel casting wheel rotating at about 11.0 meters per minute. The casting wheel was maintained at a temperature of about 35° C. using internal water circulation and by immersing the casting wheel in a water bath.

The cast sheet was passed through a bank of IR heaters set to about 310° C. to preheat the cast film prior to simultaneous stretching in the tenter oven. The cast and preheated film was immediately simultaneously stretched in longitudinal (MD) and transverse (TD) directions to produce biaxially oriented film. Final area stretch ratio of about 47:1 was used. The MD and TD ratios were kept approximately constant at about 5.4 times for the MDR and about 8.7 times for the TDR, so that the film was stretched either about the same in each of the MD and TD, or preferably, more in the MD than in the TD.

The tenter oven temperature set points used in the preheat zones was 160° C., in the stretching zones was 157° C., and in the annealing zones was 153° C. The film was about 50 micrometers thick and the slit widths were about 162 centimeters.

### Example 1

A multi-layer release liner sample was prepared by coextrusion and orienting using the method described in Example A above using PP and PE. The PP layer was 46 micrometers (1.8 mils) and the PE layer was 3.8 micrometers (0.15 mils). The optical properties of luminous transmission, haze, clarity and optical angle were measured using the test methods described above, and the results are presented in Table 1 below. Release testing was carried out according to the test method described above, and the results are presented in Table 2 below.

### Example 2

A multi-layer release liner sample was prepared by coextrusion and orienting using the method described in Example B above using PP and a blend of PE and 2% by weight of Polymeric Additive-1. The PP layer was 46 micrometers (1.8 mils) and the PE/Polymeric Additive-1 layer was 3.8 micrometers (0.15 mils). The optical properties of luminous transmission, haze, clarity and optical angle were measured using the test methods described above, and the results are presented in Table 1 below. Release testing was carried out with the 3 pressure sensitive adhesive tape samples PSA-1, PSA-2 and PSA-3 according to the test method described above, and the results are presented in Table 2 below.

TABLE 1

| | Location on | Optical | | Luminous | |
|---|---|---|---|---|---|
| | Web (cm | Angle | Haze | Transmission | Clarity |
| Example | from center) | (°) | (%) | (%) | (%) |
| 1 | −323 | 16 | NM | NM | NM |
| | −244 | 8 | 0.77 | 92.6 | 95.6 |
| | −86 | 3 | 0.81 | 92.4 | 94.7 |
| | 86 | 5 | 0.75 | 92.8 | 94.2 |
| | 244 | 11 | 0.92 | 93.4 | 95.8 |
| | 323 | 17 | 0.92 | 93.4 | 95.8 |
| 2 | −323 | 9 | NM | NM | NM |
| | −244 | 4.5 | 2.7 | 94 | 93 |
| | −86 | 2 | 3.2 | 94 | 93 |
| | 86 | 3 | 3.0 | 94 | 92 |
| | 244 | 6.5 | 2.8 | 93 | 93 |
| | 323 | 10 | NM | NM | NM |

NM = not measured

TABLE 2

| | | Release | Release | Release | Release |
|---|---|---|---|---|---|
| | | Force after | Force after | Force after | Force after |
| | | 24 hours at | 29 days at | 72 hours at | 1 week at |
| | PSA | RT | RT | 70° C. | 70° C. |
| Example | Tested | (N/dm) | (N/dm) | (N/dm) | (N/dm) |
| 1 | PSA-1 | 1.3 | 2.0 | 1.4 | 1.5 |
| | PSA-2 | 2.6 | 2.9 | 1.0 | 1.3 |
| 2 | PSA-1 | 0.92 | 1.4 | 1.3 | 1.4 |
| | PSA-2 | 1.2 | 1.4 | 1.1 | 1.0 |

### Example 3

A multi-layer protective sheet sample was prepared by coextrusion and orienting using the method described in Example A above using PP and PE. The PP layer was 46 micrometers (1.8 mils) and the PE layer was 3.8 micrometers (0.15 mils). Peel force testing was carried out according to the test method described above, and the results are presented in Table 3 below.

### Example 4

A multi-layer protective sheet sample was prepared by coextrusion and orienting using the method described in Example B above using PP and a blend of PE and 2% by weight of Polymeric Additive-1. The PP layer was 46 micrometers (1.8 mils) and the PE/Polymeric Additive-1 layer was 3.8 micrometers (0.15 mils). Peel force testing was carried out according to the test method described above, and the results are presented in Table 3 below.

TABLE 3

| | Peel | Peel | | Peel |
|---|---|---|---|---|
| | force from | force from | Peel | force from |
| | Stainless | Stainless | force from | PET after |
| | Steel after | Steel after | PET after | 24 hours at |
| | 24 hours | 72 hours | 24 hours | 72 hours |
| | at RT | at 70° C. | at RT | at 70° C. |
| Example | (N/dm) | (N/dm) | (N/dm) | (N/dm) |
| 3 | 0.13 | 2.43 | 0.49 | 0.68 |
| 4 | 0.089 | 1.21 | 0.17 | 0.36 |

1. A multi-layer article comprising:
a polypropylene-based film, and
a layer on at least one surface of the polypropylene-based film comprising an ethylene-based material comprising a copolymer of ethylene and at least one alpha-olefin comomoner with a density of no greater than 0.90 g/cm³ and a polydispersity index of between 1 and 4, wherein the multi-layer article is biaxially stretched.

2. The multi-layer article of claim 1 wherein the stretched article exhibits a luminous transmission of greater than or equal to 90%, haze of less than or equal to 4% and a retardation effect as measured by the optical angle test of less than or equal to 10°.

3. The multi-layer article of claim 1 wherein the layer comprising an ethylene-based material further comprises a silicone polyoxamide polymer.

4. The multi-layer article of claim 1 wherein the layer comprising an ethylene-based material further comprises an antistatic agent.

5. The multi-layer article of claim 1 wherein the article has a thickness of less than or equal to 102 micrometers.

6. The multi-layer article of claim 5 wherein the thickness of the layer comprising an ethylene-based material is less than or equal to 10.2 micrometers.

7. The multi-layer article of claim 1 further comprising an adhesive coated on the polypropylene-based film opposite to the layer comprising an ethylene-based material.

8. The multi-layer article of claim 7 wherein the adhesive comprises a pressure sensitive adhesive selected from acrylates, methacrylates, natural rubbers, synthetic rubbers, block copolymers, olefins, vinyl ethers, polyurethanes, polyureas, silicones or mixtures thereof.

9. The multi-layer article of claim 1 wherein the multi-layer article is a release liner.

10. The multi-layer article of claim 1 wherein the multi-layer article is a protective sheet article.

11. The multi-layer article of claim 2 wherein the stretched article exhibits a retardation effect as measured by the optical angle test of less than or equal to 10° across the width of the article.

12. A method of preparing a multi-layer article comprising:
providing a polypropylene-based material;
providing an ethylene-based material comprising a copolymer of ethylene and at least one alpha-olefin comomoner with a density of no greater than 0.90 g/cm³ and a polydispersity index of between 1 and 4;
adding the polypropylene-based material to an extruder;
adding the ethylene-based material to a different extruder;
coextruding the polypropylene-based material and the ethylene-based material through a die to form a polypropylene-based film with a layer comprising an ethylene-based material; and
simultaneously biaxially orienting the polypropylene-based film with a layer comprising an ethylene-based material to form a multi-layer article that exhibits a luminous transmission of greater than or equal to 90%, haze of less than or equal to 4% and a retardation effect as measured by the optical angle test of less than or equal to 10°.

13. The method of claim 12 wherein the ethylene-based material further comprises a silicone polyoxamide polymer.

14. The method of claim 12 wherein the ethylene-based material further comprises an antistatic agent.

15. The method of claim 12 wherein the article has a thickness of less than or equal to 102 micrometers.

16. The method of claim 15 wherein the layer comprising an ethylene-based material is less than or equal to 10.2 micrometers.

17. A method of preparing a multi-layer article comprising:
providing a polypropylene-based film;
providing an ethylene-based material comprising a copolymer of ethylene and at least one alpha-olefin comomoner with a density of no greater than 0.90 g/cm³ and a polydispersity index of between 1 and 4;
adding the ethylene-based material to an extruder;
extruding the ethylene-based material through a die onto the polypropylene-based film to form a polypropylene-based film with a layer comprising an ethylene-based material; and
simultaneously biaxially orienting the polypropylene-based film with a layer comprising ethylene-based material to form a multi-layer article that exhibits a luminous transmission of greater than or equal to 90%, haze of less than or equal to 4% and a retardation effect as measured by the optical angle test of less than or equal to 10°.

18. A multi-layer construction comprising:
an optical device;
an adhesive coated on the optical device; and
a liner laminated to the adhesive, wherein the liner comprises a multi-layer article comprising:
a polypropylene-based film, and
a layer on at least one surface of the polypropylene-based film comprising an ethylene-based material comprising a copolymer of ethylene and at least one alpha-olefin comomoner with a density of no greater than 0.90 g/cm³ and a polydispersity index of between 1 and 4,
wherein the multi-layer article is biaxially stretched and exhibits a luminous transmission of greater than or equal to 90%, haze of less than or equal to 4% and a retardation effect as measured by the optical angle test of less than or equal to 10°.

19. The multi-layer construction of claim 18 wherein the optical device comprises an optical film.

20. The multi-layer construction of claim 19 wherein the optical film comprises a visible mirror film, a color mirror film, a solar reflective film, a diffusive film, an infrared reflective film, an ultraviolet reflective film, a reflective polarizer film such as a brightness enhancement film or a dual brightness enhancement film, an absorptive polarizer film, an optically clear film, a tinted film, or an antireflective film.

21. The multi-layer construction of claim 18 wherein the optical device comprises a graphic article or an information display device.

22. A method of testing an optical construction comprising:
preparing an optical construction comprising:
an optical device;
an adhesive coated on the optical device; and
a liner laminated to the adhesive, wherein the liner comprises a multi-layer article comprising:
a polypropylene-based film, and a layer on at least one surface of the polypropylene-based film comprising an ethylene-based material comprising a copolymer of ethylene and at least one alpha-olefin comomoner with a density of no greater than 0.90 g/cm³ and a polydispersity index of between 1 and 4, wherein the multi-layer article is biaxially stretched and exhibits a luminous transmission of greater than or equal to 90%, haze of less than or equal to 4% and a retardation effect as measured by the optical angle test of less than or equal to 10°;
placing the optical construction between 2 linear polarizers set perpendicular to each other; and
rotating the optical construction to determine the optical angle.
